(19) United States
(12) Patent Application Publication
(10) Pub. No.: US 2009/0106188 A1
(43) Pub. Date: Apr. 23, 2009

(54) IMAGE PROCESSOR, STORED DOCUMENT MANAGEMENT METHOD, AND STORED DOCUMENT MANAGEMENT SYSTEM

(76) Inventor: Jun TAKAHASHI, Fujisawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/255,179

(22) Filed: Oct. 21, 2008

(30) Foreign Application Priority Data
Oct. 22, 2007 (JP) 2007-274151
May 27, 2008 (JP) 2008-138086

(51) Int. Cl. G06F 17/30

(52) U.S. Cl. 707/1; 707/E17.008

(57) ABSTRACT

An image processor includes a document name list acquisition unit, a document name list storage device, a document acquisition unit, and a document name assignment unit. The document name list acquisition unit acquires information of a document name list including a document name of each of a plurality of documents to be stored in the image processor. The document name list storage device stores the information of the document name list. The document acquisition unit acquires information of the plurality of documents. The document name assignment unit acquires the document name corresponding to each of the plurality of documents from the information of the document name list stored in the document name list storage device and assigns the document name to each of the plurality of documents.

### CROSS-REFERENCE TO RELATED APPLICATIONS

The present application is based on and claims priority from Japanese Patent Application Nos. 2007-274151, filed on Oct. 22, 2007, and 2008-138086, filed on May 27, 2008 in the Japan Patent Office, the entire contents of each of which are hereby incorporated herein by reference.

### BACKGROUND OF THE INVENTION

1. Field of the Invention

Exemplary aspects of the present invention relate to an image processor, a stored document management method, and a stored document management system, and more particularly, to an image processor, a stored document management method, and a stored document management system for efficiently assigning a document name to a stored document.

2. Description of the Related Art

Related-art image processors, such as copiers, facsimile machines, printers, or multifunction printers having at least one of copying, printing, scanning, and facsimile functions, accumulate document information read by a scanner to allow the document information to be shared among a plurality of PC (personal computer) users via a network, so that the PC users can freely transmit and receive the document information, print an image of the document, or the like. In storage of the document, the image processors generally assign a document name to identify the document.

However, such image processors automatically assign a document name including a series of numbers, dates, and other data that are difficult for a user to recognize, making it difficult for a user to find a target document among a plurality of documents.

To address this issue, for example, a related-art digital copier system assigns an easily recognizable document name to a stored document. That is, a user can enter an arbitrary document name including a title or a content of the document. Specifically, when the user inputs the document name using a PC connected to a digital copier via a network, the document name is stored in advance in an external storage device of the digital copier. After scanning an original document, in response to the user's request the digital copier accesses a document database stored in the external storage device and displays a document information list to the user. Then, the user specifies the document name from the document information list.

However, in the above system, the user in advance needs to manually input the document name using a keyboard, which leaves room for input error. In addition, such manual input places an added burden on the user, especially when the user has to handle many documents.

Obviously, such input error due to manual input of a document name is undesirable, and accordingly, there is a need for a technology to efficiently assign an easily recognizable document name to a stored document without burdening the user.

### BRIEF SUMMARY OF THE INVENTION

This specification describes an image processor according to exemplary embodiments of the present invention. In one exemplary embodiment of the present invention, the image processor includes a document name list acquisition unit, a document name list storage device, a document acquisition unit, and a document name assignment unit. The document name list acquisition unit is configured to acquire information of a document name list including a document name of each of a plurality of documents to be stored in the image processor. The document name list storage device is configured to store the information of the document name list. The document acquisition unit is configured to acquire information of the plurality of documents. The document name assignment unit is configured to acquire the document name corresponding to each of the plurality of documents from the information of the document name list stored in the document name list storage device and assign the document name to each of the plurality of documents.

This specification further describes a stored document management method according to exemplary embodiments of the present invention. In one exemplary embodiment of the present invention, the stored document management method includes acquiring information of a document name list including a document name of each of a plurality of documents to be stored in an image processor, storing the information of the document name list, acquiring information of the plurality of documents, acquiring the document name corresponding to each of the plurality of documents from the information of the document name list, and assigning the acquired document name to each of the plurality of documents.

This specification further describes a stored document management system according to exemplary embodiments of the present invention. In one exemplary embodiment of the present invention, the stored document management system includes an image processor and an information processor. The image processor is configured to perform image processing. The information processor is configured to transmit and receive data to and from the image processor via a network. The image processor includes a document name list acquisition unit, a document name list storage device, a document acquisition unit, and a document name assignment unit as described above.

### BRIEF DESCRIPTION OF THE DRAWINGS

A more complete appreciation of the invention and the many attendant advantages thereof will be more readily obtained as the same becomes better understood by reference to the following detailed description when considered in connection with the accompanying drawings, wherein:

FIG. 1 is a hardware configuration diagram of an image processor according to an exemplary embodiment of the present invention;

FIG. 2 is a functional block diagram of the image processor shown in FIG. 1;

FIG. 3 is a flowchart illustrating a process of storing a document name list in the image processor shown in FIG. 2;

FIG. 4 is a diagram illustrating a document name list generated by the image processor shown in FIG. 2;

FIG. 5 is a diagram of one example of document attributes included in the document name list shown in FIG. 4;

FIG. 6 is a diagram illustrating transition of a screen displayed when storing the document name list in the image processor shown in FIG. 2;

FIG. 7 is a schematic diagram illustrating an information processor, a network, and the image processor shown in FIG. 1;

FIG. 8 is a flowchart illustrating a process of assigning a document name from the document name list to a document stored in the image processor shown in FIG. 2;

FIG. 9 is a diagram illustrating transition of a screen displayed when assigning an attribute to a document read by the image processor shown in FIG. 2;

FIG. 10 is a diagram illustrating an assignment of a document name listed on the document name list shown in FIG. 4 to a document stored in the image processor shown in FIG. 2;

FIG. 11 is a diagram illustrating an assignment of a document name listed on the document name list shown in FIG. 4 to a document stored in the image processor shown in FIG. 2 according to a registration order of the document;

FIG. 12 is a diagram illustrating an assignment of a document name with a degree of importance listed on the document name list shown in FIG. 4 to a document stored in the image processor shown in FIG. 2;

FIG. 13 is a diagram illustrating an assignment of a document name with an expiry date listed on the document name list shown in FIG. 4 to a document stored in the image processor shown in FIG. 2;

FIG. 14 is a diagram illustrating an assignment of a document name with identification information to a document stored in the image processor shown in FIG. 2; and

FIG. 15 is diagram of a display example after a document is stored in the image processor shown in FIG. 2.

### DETAILED DESCRIPTION OF THE INVENTION

In describing exemplary embodiments illustrated in the drawings, specific terminology is employed for the sake of clarity. However, the disclosure of this specification is not intended to be limited to the specific terminology so selected, and it is to be understood that each specific element includes all technical equivalents that operate in a similar manner and achieve a similar result.

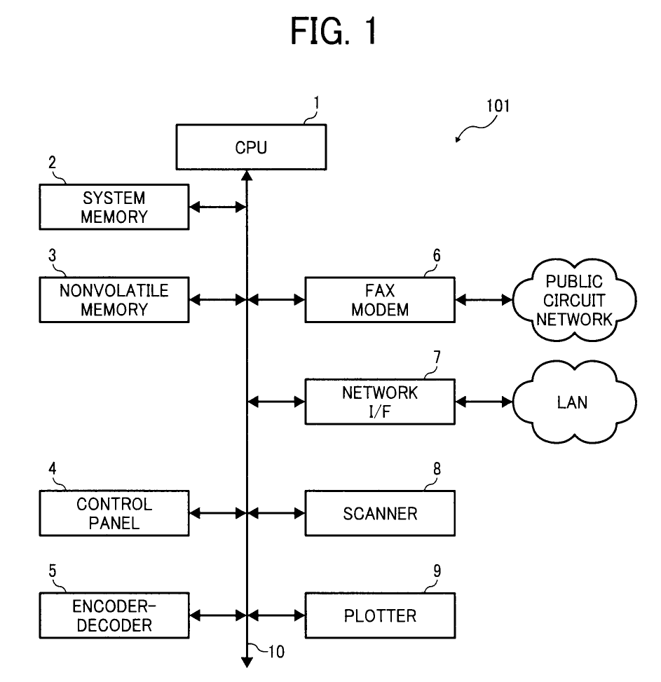

Referring now to the drawings, wherein like reference numerals designate identical or corresponding parts throughout the several views, in particular to FIG. 1, an image processor 101 according to an exemplary embodiment of the present invention is described.

Referring to FIG. 1, a description is now given of a hardware configuration of the image processor 101. FIG. 1 is a schematic diagram of the hardware configuration of the image processor 101. The image processor 101 includes a CPU (central processing unit) 1, a system memory 2, a nonvolatile memory 3, a control panel 4, an encoder-decoder 5, a fax modem 6, a network I/F (interface) 7, a scanner 8, a plotter 9, and a bus 10.

The CPU 1 controls each unit of the image processor 101. The system memory 2 stores a control program executed by the CPU 1 and various types of data or the like necessary for executing the control program. The nonvolatile memory 3 permanently retains setting data and information even when not powered. For example, the nonvolatile memory 3 stores an address book and various setting information. The control panel 4 includes various operation keys and various indicators used for operation of the image processor 101. The encoder-decoder 5 encodes and decodes image data. For example, the encoder-decoder 5 compresses and encodes image data into image information for facsimile transmission and decodes the encoded image data into the original image data. In addition, the encoder-decoder 5 encodes image data as MIME (multipurpose internet mail extensions) data for e-mail transmission and decodes the encoded MIME data. The fax modem 6 is connected to a public circuit network, and performs conversion between a digital signal transmitted from a facsimile machine and an analog signal transmitted from the public circuit network, thereby sending and receiving a fax to and from the public circuit network according to a G3 protocol. The network I/F 7 is connected to a LAN (local area network), and exchanges data and e-mail through the LAN according to a protocol, for example, TCP/IP (transmission control protocol/internet protocol) or the like. The scanner 8 reads an image formed on an original document at a predetermined resolution. The plotter 9 draws an image on a sheet and prints the sheet at a predetermined resolution. The above devices are connected to each other via the bus 10 to exchange data with each other via the bus 10.

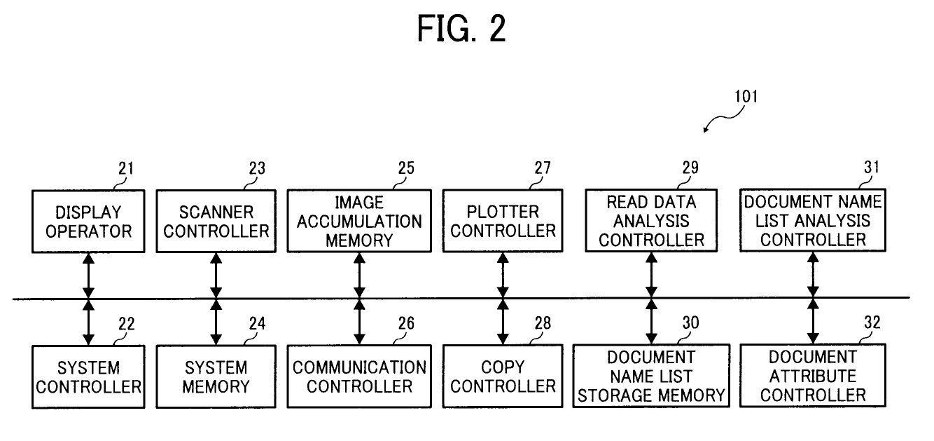

FIG. 2 is a functional block diagram of the image processor 101 according to the exemplary embodiment. The image processor 101 further includes a display operator 21, a system controller 22, a scanner controller 23, a system memory 24, an image accumulation memory 25, a communication controller 26, a plotter controller 27, a copy controller 28, a read data analysis controller 29, a document name list storage memory 30, a document name list analysis controller 31, and a document attribute controller 32.

The display operator 21, serving as an assigned document name display unit, which is implemented by the control panel 4 depicted in FIG. 1, includes a key, a LED (light emitting diode), a LCD (liquid crystal display), and the like, to receive a user's input operation. The system controller 22, under control of the CPU 1 depicted in FIG. 1, performs authentication and controls the image processor 101 as a whole. The scanner controller 23, under control of the CPU 1, commands the scanner 8 depicted in FIG. 1 to read an original document. The system memory 24, which is implemented by the system memory 2 depicted in FIG. 1, serves as a work area used for system control. The image accumulation memory 25, which is implemented by the nonvolatile memory 3 depicted in FIG. 1, accumulates image information as needed. The communication controller 26, under control of the CPU 1, performs transmission and reception of various communications among the encoder-decoder 5, the fax modem 6, and the network I/F 7. The plotter controller 27, under control of the CPU 1, commands the plotter 9 depicted in FIG. 1 to record received image information, report, and the like. The copy controller 28, under control of the CPU 1, commands the scanner 8, the plotter 9, and the like, to copy an image. The read data analysis controller 29, under control of the CPU 1, analyzes read data using an OCR (optical character reader) or the like. The document name list storage memory 30, which is implemented by the system memory 2 or the nonvolatile memory 3, stores the analyzed data. The document name list analysis controller 31, under control of the CPU 1, analyzes a document name list. The document attribute controller 32, serving as a document name assignment unit, under control of the CPU 1, assigns a document name or the like to a stored document. It is to be noted that the document name list means a document listing document names, an order of registration, and the like, prepared and supplied by a user.

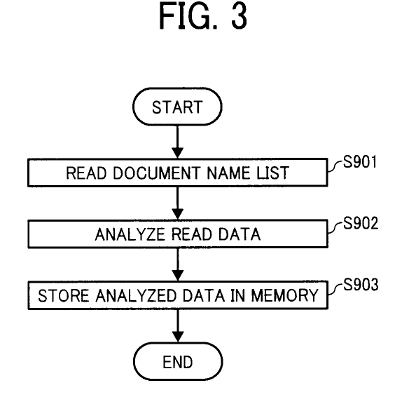

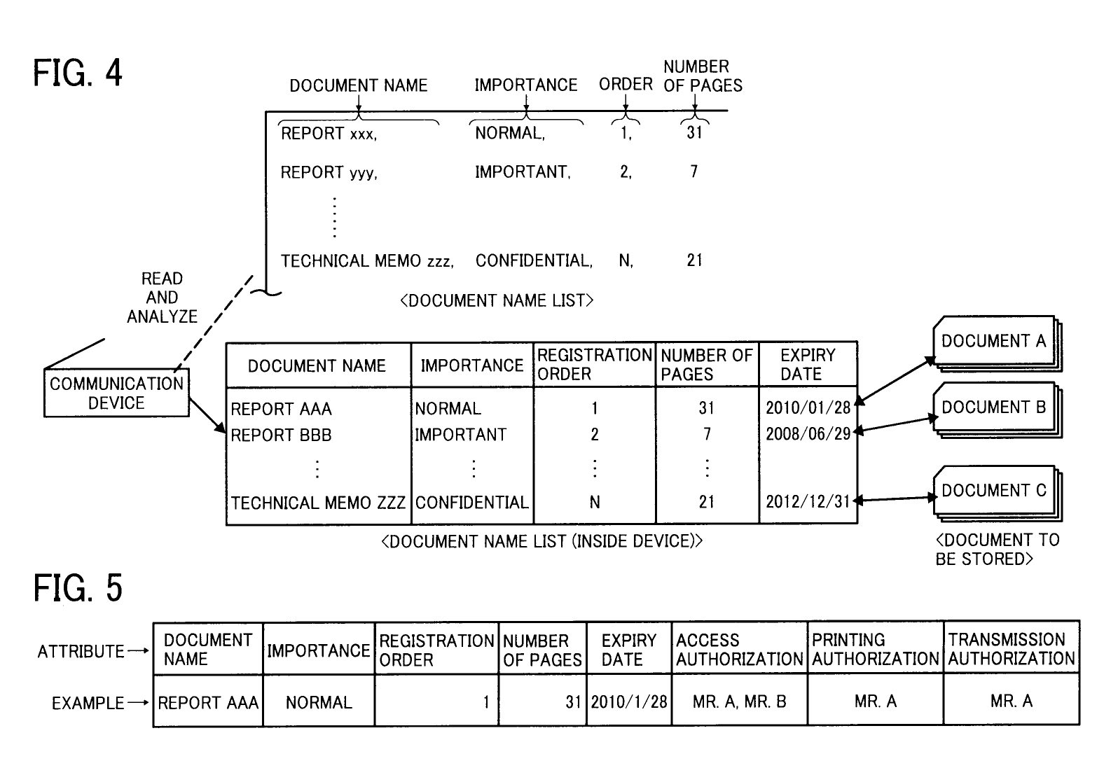

Referring to FIGS. 3, 4, 5, 6, and 7, a description is now given of an operation of the image processor 101 according to this exemplary embodiment. FIG. 3 is a flowchart illustrating a process of storing a document name list in the image processor 101. FIG. 4 is a schematic diagram of the operation of the image processor 101, which illustrates a document name list prepared by a user and a document name list generated based on the document name list prepared by the user and stored in the image processor 101. FIG. 5 is a list of one example of document attributes.

As illustrated in FIG. 3, in step S901, the communication controller 26, serving as a document name list acquisition unit, reads data of a document name list prepared by a user in FIG. 4. Then, in step S902, the read data analysis controller 29 analyzes the read data using the OCR and the like. Thereafter, in step S903, when the document name list storage memory 30, serving as a document name list storage device, stores the analyzed data, the document name list (inside device) as illustrated in FIG. 4 is generated.

According to this exemplary embodiment, as illustrated in FIG. 5, document attributes include a document name, a degree of importance, registration order, the number of pages, expiry date, access authorization, printing authorization, and transmission authorization. However, the attributes are not limited to those described above.

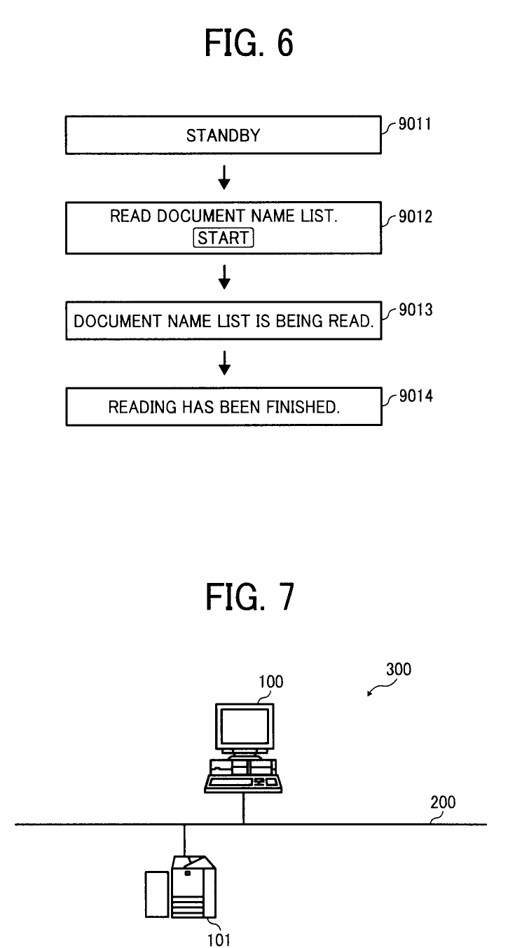

FIG. 6 is a schematic diagram illustrating a transition of a screen displayed on the control panel 4 depicted in FIG. 1 when the communication controller 26 reads data of the document name list prepared by the user in step S901 as illustrated in FIG. 3. FIG. 7 is a schematic diagram of a stored document management system 300 for illustrating a data acquisition method. The stored document management system 300 includes an information processor 100, the image processor 101, and a network 200.

As illustrated in FIG. 6, in an initial state, the control panel 4 displays a screen 9011 showing a message “Standby”. In response to a predetermined operation by a user, the control panel 4 displays a screen 9012 for allowing the user to command to read the document name list prepared by the user. The screen 9012 includes a “START” key. It is to be noted that information to be read may be either written on paper or stored as data. For example, as illustrated in FIG. 7, the image processor 101 receives data from the information processor 100 including an external PC (personal computer) via the network 200.

Referring back to FIG. 6, when the user presses the “START” key displayed on the screen 9012, the control panel 4 switches to a screen 9013 indicating that the document name list prepared by the user is being read. After completion of reading the document name list prepared by the user, the control panel 4 displays a screen 9014 showing that the document name list prepared by the user has finished being read.

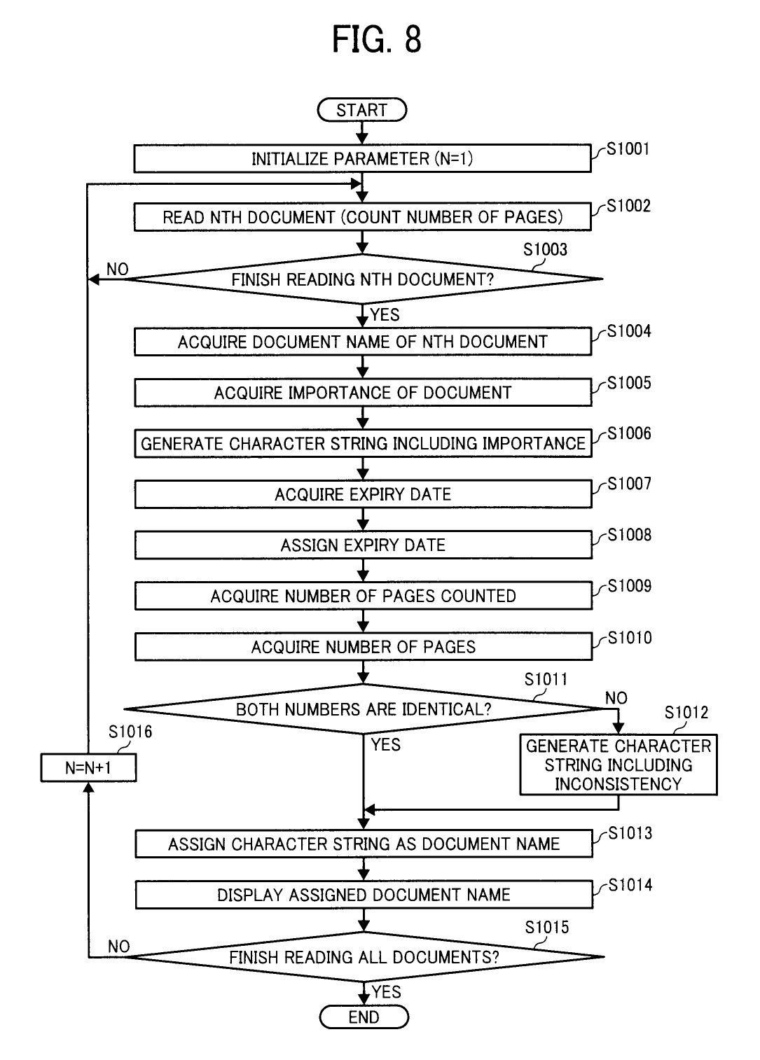

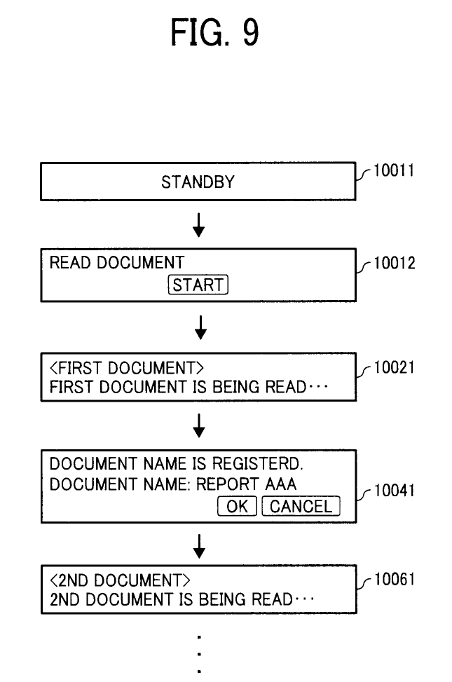

Referring to FIGS. 8 and 9, a description is now given of steps in a process of assigning a document name and the like to a stored document from the document name list generated and stored in the image processor 101 based on the read document name list prepared by the user. FIG. 8 is a flowchart illustrating a process of assigning a document name and the like when the image processor 101 accumulates a plurality of documents. FIG. 9 is a schematic diagram of transition of a screen displayed on the control panel 4.

As illustrated in FIG. 8, in step S1001, when the system controller 22 depicted in FIG. 2 initializes a parameter N for indicating an order of a document, the control panel 4 displays a standby screen 10011, as illustrated in FIG. 9. In response to a predetermined operation, the screen 10011 changes to a screen 10012 for allowing the user to command to start reading an nth document. The screen 10012 includes a “START” key.

When the user sets a document in the scanner 8 depicted in FIG. 1 and presses the “START” key displayed on the screen 10012, the scanner 8 reads the nth document in step S1002. Then, the control panel 4 displays a screen 10021 indicating that the scanner 8 is reading the nth document. When doing so, the scanner 8 counts the number of pages of the document in step S1002.

In step S1003, the scanner controller 23, serving as a document acquisition unit, confirms whether or not the scanner 8 finishes reading the nth document. When the scanner 8 does not finish reading the nth document (NO at step S1003), processing returns to step S1002 and the scanner 8 continues to read the document. When the scanner 8 finishes reading the nth document (YES at step S1003), the document attribute controller 32 acquires a document name listed in the nth order on the document name list. Alternatively, the document attribute controller 32 searches for a numeric value N from information of the registration order listed on the document name list to acquire the corresponding document name in step S1004.

In step S1005, the document attribute controller 32 acquires a degree of importance of the document associated with the document name, and generates a character string combining a string according to the importance and a string of the document name in step S1006. Thereafter, in step S1007, the document attribute controller 32 acquires an expiry date associated with the document name acquired in step S1004, and assigns the expiry date as an attribute of the document in step S1008.

In step S1009, the document attribute controller 32 acquires the number of pages of the read document counted in step S1002. In step S1010, the document attribute controller 32 acquires the number of pages of the nth document associated with the document name acquired in step S1004. In step S1011, the document attribute controller 32 compares the number of pages acquired in step S1009 with the number of pages acquired in step S1010.

As a result of the comparison in step S1011, when both numbers are identical (YES at step S1011), the document attribute controller 32 assigns the character string acquired in step S1006 to the stored document as a document name in step S1013. When both numbers are not identical (NO at step S1011), in step S1012, the document attribute controller 32 generates a character string combining the character string acquired in step S1006 with a character string representing inconsistency of the numbers of pages, and assigns the generated character string to the stored document as a document name in step S1013. In step S1014, the system controller 22 commands the display operator 21 to display the document name on the control panel 4.

When the system controller 22 commands the display operator 21 to display the document name on the control panel 4 in step S1014, the control panel 4 displays a screen 10041, for example, as illustrated in FIG. 9, indicating that a document name “REPORT AAA” has been registered. The screen 10041 includes an “OK” key and a “CANCEL” key. Pressing the “OK” key allows the user to proceed to a next operation of reading a second document. Alternatively, however, the scanner controller 23 may automatically perform the next operation after the control panel 4 displays the screen 10041 for a predetermined time period. In such a case, the screen 10041 may not include the “OK” key.

Referring back to FIG. 8, in step S1015, the scanner controller 23 subsequently confirms whether or not the scanner 8 finishes reading all documents. When the scanner 8 does not finish reading all the documents (NO at step S1015), the system controller 22 updates the parameter N in step S1016, and processing returns to step S1002, where the scanner controller 23 commands the scanner 8 to read a next document. As illustrated in FIG. 9, the control panel 4 displays a screen 10061 indicating that the second document is being read. Processing is repeated until the scanner 8 finishes reading all the documents. When the scanner 8 finishes reading all the documents (YES at step S1015), processing ends.

Examples of automatic assignment of document names to stored documents are described below.

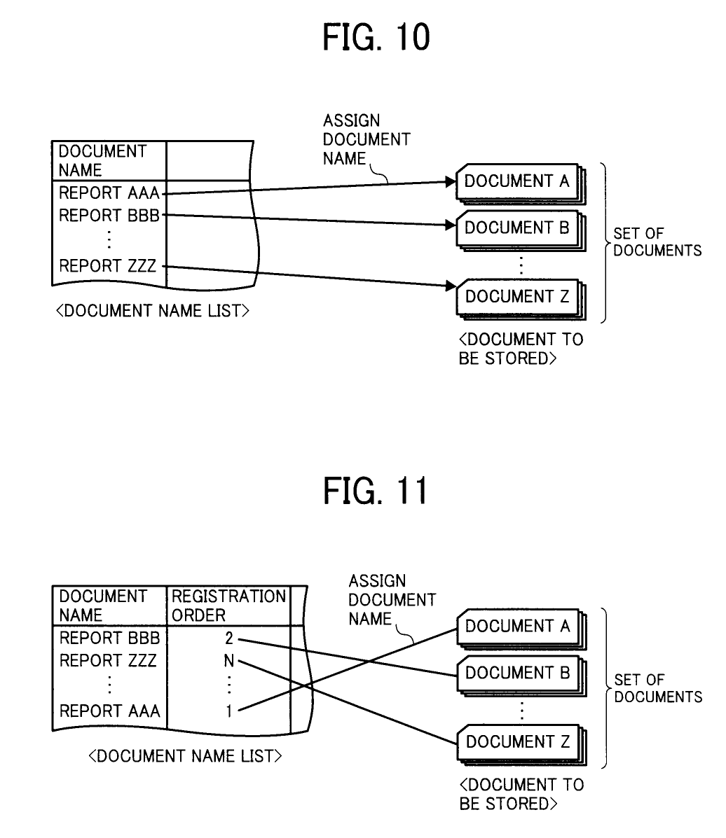

FIG. 10 illustrates an assignment by the document attribute controller 32 of a document name listed on the document name list shown in FIG. 3 to a document stored in the image processor 101 depicted in FIG. 1. For example, as illustrated in FIG. 10, a document name “REPORT AAA” is automatically assigned to a document A.

FIG. 11 illustrates an assignment by the document attribute controller 32 of a document name listed on the document name list shown in FIG. 3 to a document stored in the image processor 101 according to a registration order of the document. As illustrated in FIG. 11, a document name “REPORT AAA” is automatically assigned to a document A according to the registration order.

Such automatic assignment by the document attribute controller 32 of the document name to a stored document as described above can reduce a user's workload and prevent input error.

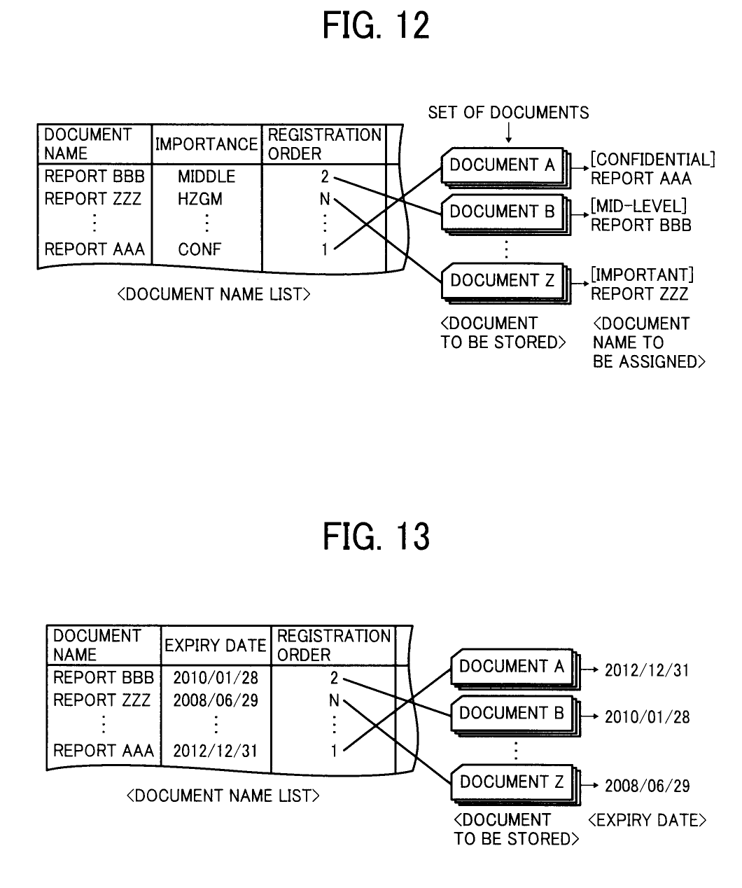

FIG. 12 illustrates an example of a document name when the document attribute controller 32 automatically assigns a document name including a string representing a degree of importance to a stored document in step S1006 in FIG. 8. For example, a document name “REPORT AAA”, to which a degree of importance “CONFIDENTIAL” is added, is assigned to a document A according to the registration order.

FIG. 13 illustrates an example of an assignment of an expiry date to a stored document. As described above with reference to FIG. 8, the document attribute controller 32 assigns an expiry date listed on the document name list to a stored document in step S1008. For example, an expiry date “2012/12/31” is automatically assigned to a document A according to the registration order. Such automatic assignment of the expiry date to a stored document can reduce a user's load and input error.

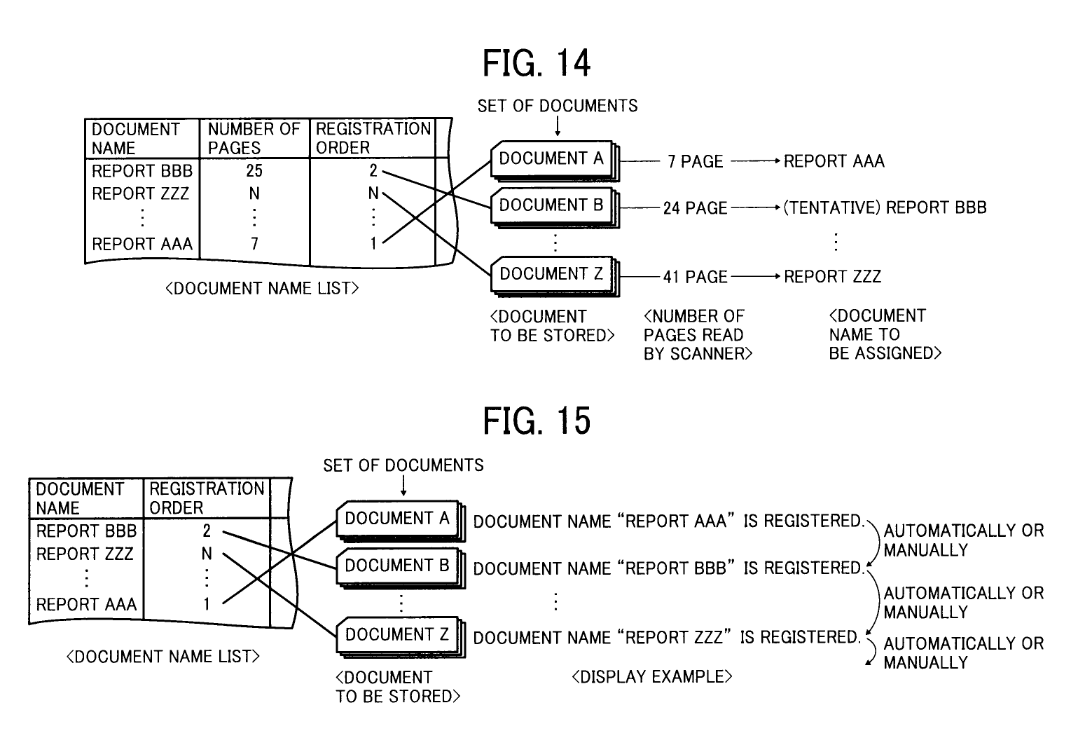

FIG. 14 illustrates an example of a document name when the document attribute controller 32 automatically assigns a document name including a character string indicating inconsistency between the number of pages listed on the document name list and the actual number of pages read by the scanner 8, in step S1013 in FIG. 8. For example, when the number of pages listed on the document name list is 25, whereas the actual number of pages read by the scanner 8 is 24, the document attribute controller 32 automatically assigns a document name “(TENTATIVE) REPORT BBB” to a document B.

FIG. 15 illustrates a display example of a message to the user displayed on the control panel 4 in step S1014 in FIG. 8. For example, the display controller 21 displays a message “DOCUMENT NAME “REPORT AAA” IS REGISTERED” on the control panel 4. As described above, after the control panel 4 displays the above message for a predetermined time period, the scanner 8 may automatically start reading a next document. Alternatively, after the user confirms the message displayed on the control panel 4, the user may manually start operation of reading the next document.

According to this exemplary embodiment, when the image processor 101 accumulates a plurality of documents, since the image processor 101 includes a document name assignment unit, that is, the document attribute controller 32 depicted in FIG. 2, which automatically assigns a document name to the stored document according to a registration order listed on a document name list, a user does not need to manually enter a document name of each document using a keyboard. As a result, the amount of work done by the user can be substantially reduced, thereby also preventing input error due to manual operation while improving operability and enhancing user convenience.

According to this exemplary embodiment, when the image processor 101 accumulates a set of multiple documents arranged in an order different from a registration order listed on a document name list, since the image processor 101 includes a document name assignment unit, that is, the document attribute controller 32 depicted in FIG. 2, which assigns the document name to the stored document according to a numerical value stored in the document name list, a user does not need to rearrange the set of the documents in the order of the documents on the document name list. As a result, the image processor 101 can assign a proper document name to each of the plurality of documents, thereby enhancing user convenience.

According to this exemplary embodiment, since the image processor 101 includes a document name assignment unit, that is, the document attribute controller 32 depicted in FIG. 2, which adds a character string to the document name according to a degree of importance, for example, “CONFIDENTIAL”, even when a user who did not create the document operates the image processor 101 to store the document, the image processor 101 can enter a document name that reflects the degree of importance of the document, thereby enhancing user convenience.

According to this exemplary embodiment, since the image processor 101 includes a document name assignment unit, that is, the document attribute controller 32 depicted in FIG. 2, which assigns an expiry date associated with the document name to the stored document, when the image processor 101 accumulates a plurality of documents, the user does not need to manually set the expiry date of each stored document, thereby enhancing user convenience.

According to this exemplary embodiment, since the image processor 101 includes a document name assignment unit, that is, the document attribute controller 32 depicted in FIG. 2, which assigns identification information, for example, “TENTATIVE”, to the document name, when a total number of pages of the stored document is different from a total number of pages listed on the document name list, the user can easily notice that some failure, for example, double feed, occurs, and thereby the image processor 101 fails to complete accumulation of all pages of the document. As a result, user convenience increases, and so does reliability of document storage by the image processor 101.

According to this exemplary embodiment, since the image processor 101 includes an assigned document name display unit, that is, the display controller 21 depicted in FIG. 2, which displays the document name automatically assigned to each stored document, the user can easily confirm whether or not the document name assigned to the document is correct, thereby enhancing user convenience.

This invention may be implemented as convenient using a conventional general-purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

As can be appreciated by those skilled in the art, although the present invention has been described above with reference to specific exemplary embodiments the present invention is not limited to the specific embodiments described above, and various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

What is claimed is:

1. An image processor for performing image processing, comprising:
a document name list acquisition unit configured to acquire information of a document name list including a document name of each of a plurality of documents to be stored in the image processor;
a document name list storage device configured to store the information of the document name list;
a document acquisition unit configured to acquire information of the plurality of documents; and
a document name assignment unit configured to acquire the document name corresponding to each of the plurality of documents from the information of the document name list stored in the document name list storage device and assign the document name to each of the plurality of documents.

2. The image processor according to claim 1,
wherein the information of the document name list stored by the document name list storage device includes a registration order of the document names, and
wherein the document name assignment unit assigns the document name to each of the plurality of documents based on the registration order of the document names.

3. The image processor according to claim 1,
wherein the information of the document name list stored by the document name list storage device includes a registration order of the document names represented by a numerical value,
wherein the document name list storage device stores the registration order of the document names associated with the document names, and
wherein the document name assignment unit assigns the document name corresponding to each of the plurality of documents according to the registration order of the document names.

4. The image processor according to claim 1,
wherein the document name list storage device stores a degree of importance of the document associated with the document name, and
wherein the document name assignment unit adds a character string generated according to the degree of importance of the document to the document name to be assigned to each of the plurality of documents.

5. The image processor according to claim 1,
wherein the document name list storage device stores an expiry date of the document associated with the document name, and
wherein the document name assignment unit assigns a character string indicating the expiry date to each of the plurality of documents.

6. The image processor according to claim 1,
wherein the document acquisition unit acquires a total number of pages of each of the plurality of documents,
wherein the document name list storage device stores the total number of pages of the document associated with the document name, and
wherein the document name assignment unit compares the total number of pages of the document acquired by the document acquisition unit to a total number of pages of the document listed on the document name list, and when both numbers are different, the document name assignment unit adds identification information to the document name indicating that both numbers are different.

7. The image processor according to claim 1, further comprising:
an assigned document name display unit configured to display the document name assigned by the document name assignment unit.

8. A stored document management method, comprising:
acquiring information of a document name list including a document name of each of a plurality of documents to be stored in an image processor;
storing the information of the document name list;
acquiring information of the plurality of documents;
acquiring the document name corresponding to each of the plurality of documents from the information of the document name list; and
assigning the acquired document name to each of the plurality of documents.

9. A stored document management system, comprising:
an image processor configured to perform image processing; and
an information processor configured to transmit and receive data to and from the image processor via a network, the image processor comprising:
a document name list acquisition unit configured to acquire information of a document name list including a document name of each of a plurality of documents to be stored in the image processor from the information processor via the network;
a document name list storage device configured to store the information of the document name list;
a document acquisition unit configured to acquire information of the plurality of documents; and
a document name assignment unit configured to acquire the document name corresponding to each of the plurality of documents from the information of the document name list stored in the document name list storage device and assign the document name to each of the plurality of documents.
